(19) United States
(12) Patent Application Publication
(10) Pub. No.: US 2026/0089657 A1
(43) Pub. Date: Mar. 26, 2026

(54) SUPPORT OF L1 AND L2 SIGNALING BASED MOBILITY

(71) Applicant: LENOVO (BEIJING) LIMITED, Beijing (CN)

(72) Inventors: Bingchao Liu, Beijing (CN); Lianhai Wu, Beijing (CN); Ran Yue, Beijing (CN); Haiming Wang, Beijing (CN)

(21) Appl. No.: 19/109,670

(22) PCT Filed: Sep. 30, 2022
(86) PCT No.: PCT/CN2022/123175

§ 371 Date: Mar. 7, 2025

(51) Int. Cl. H04W 56/00; H04B 7/06; H04L 1/1812; H04W 36/08; H04W 72/231; H04W 80/02

(52) U.S. Cl. CPC H04W 56/0015; H04B 7/06968; H04L 1/1812; H04W 36/08; H04W 72/231; H04W 80/02

(57) ABSTRACT

Methods and apparatuses for support of L1 and L2 signaling based mobility are disclosed. In one embodiment, a UE comprises a transceiver; and a processor coupled to the transceiver, wherein the processor is configured to receive, via the transceiver, a DCI or a MAC CE indicating a serving cell change command for a target cell; and apply the target cell as the new serving cell after sending, via the transceiver, HARQ-ACK information for the DCI or the MAC CE.

### FIELD

The subject matter disclosed herein generally relates to wireless communications, and more particularly relates to methods and apparatuses for support of L1 and L2 signaling based mobility.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), layer 1 (L1), layer 2 (L2), layer 3 (L3), Primary Cell (PCell), Secondary Cell (SCell), Primary Secondary Cell (PSCell), Downlink Control Information (DCI), Medium Access Control (MAC), control element (CE), Transmission configuration Indication (TCI), physical cell identity (PCI), Synchronization signal block (SSB), bandwidth part (BWP), radio network temporary identifier (RNTI), hybrid automatic repeat request (HARQ), acknowledgement (ACK), sub-carrier space (SCS), Physical Uplink Control Channel (PUCCH), Physical Uplink Shared Channel (PUSCH), Physical Downlink Control Channel (PDCCH), Physical Downlink Shared Channel (PDSCH), channel state information (CSI), CSI reference signal (CSI-RS), CSI-RS resource indicator (CRI), quasi-colocation (QCL), channel measurement resource (CMR), SSB resource indicator (SSBRI), reference signal received power (RSRP), timing advance (TA), transmit receive point (TRP), TA group (TAG).

When the UE moves from the coverage area of one cell to another cell, a serving cell change needs to be performed. Currently, the serving cell change is triggered by L3 (layer-3, corresponding to RRC layer) measurements, and is done by reconfiguration with synchronization triggered by RRC signaling. The serving cell change includes change of PCell and PSCell, as well as releasing and adding SCells when applicable. The measurement and the change involve complete L2 (layer-2, corresponding to MAC layer) and L1 (layer-1, corresponding to physical layer) resets, leading to longer latency, larger overhead and longer interruption time than beam switch mobility.

This invention targets mobility latency reduction, and in particular, enabling a serving cell change via L1 and L2 signaling.

### BRIEF SUMMARY

Methods and apparatuses for support of L1 and L2 signaling based mobility are disclosed.

In one embodiment, a UE comprises a transceiver; and a processor coupled to the transceiver, wherein the processor is configured to receive, via the transceiver, a DCI or a MAC CE indicating a serving cell change command for a target cell; and apply the target cell as the new serving cell after sending, via the transceiver, HARQ-ACK information for the DCI or the MAC CE.

In some embodiment, the DCI indicates a unified TCI state from activated two or more TCI states, wherein the unified TCI state is associated with SSBs associated with a physical cell ID identifying one of candidate target cells, and the serving cell change command indicates to apply the target cell that is the one of the candidate target cells. For example, the DCI is a DCI with format 1_1 or 1_2 including a new field indicating the serving cell change command, or a DCI with format 1_1 or 1_2 without DL assignment including a reserved field indicating the serving cell change command.

In some embodiment, the MAC CE activates one unified TCI state, wherein the one unified TCI state is associated with SSBs associated with a physical cell ID identifying one of candidate target cells, and the serving cell change command indicates to apply the target cell that is the one of the candidate target cells.

In some embodiment, the DCI indicates a physical cell ID indicating one of candidate target cells, as the serving cell change command, and the serving cell change command indicates to apply the target cell that is the one of the candidate target cells. For example, the DCI is a dedicated DCI format or a DCI format 1_1 or 1_2 scrambled by a dedicated RNTI.

In some embodiment, the processor is configured to apply the target cell starting from the first slot that is at least x symbols after the last symbol of PUCCH or PUSCH carrying the HARQ-ACK information for the DCI, wherein x is reported by the UE capability reporting per SCS.

In some embodiment, the processor is further configured to receive all PDCCH and PDSCH by the unified TCI state, starting from the first slot that is at least x symbols after the last symbol of PUCCH or PUSCH carrying the HARQ-ACK information for the DCI, wherein x is reported by the UE capability reporting per SCS.

In some embodiment, the processor is further configured to receive, via the transceiver, a CSI report configuration; and transmit, via the transceiver, a beam report including one or more beam index or indices with the measured L1-RSRP, where each of the one or more beam index or indices identifies a beam from a different cell whose average L1-RSRP of the top K beams is larger than a configured threshold, wherein the beam report also includes the average L1-RSRP of the top K beams for each cell for which a beam index of a beam is included in the beam report, wherein, K is a preconfigured value.

In some embodiment, the DCI or the MAC CE further indicates a TAG ID. Alternatively, the unified TCI state or the physical cell ID identifying the target cell is associated with a TAG ID.

In another embodiment, a method performed at a UE comprises receiving a DCI or a MAC CE indicating a serving cell change command for a target cell; and applying the target cell as the new serving cell after sending HARQ-ACK information for the DCI or the MAC CE

In still another embodiment, a base unit comprises a transceiver; and a processor coupled to the transceiver, wherein the processor is configured to transmit, via the transceiver, a DCI or a MAC CE indicating a serving cell change command for a target cell; and apply the target cell as the new serving cell after receiving, via the transceiver, HARQ-ACK information for the DCI or the MAC CE.

In some embodiment, the DCI indicates a unified TCI state from activated two or more TCI states, wherein the unified TCI state is associated with SSBs associated with a physical cell ID identifying one of candidate target cells, and the serving cell change command indicates to apply the target cell that is the one of the candidate target cells. For example, the DCI is a DCI with format 1_1 or 1_2 including a new field indicating the serving cell change command, or a DCI with format 1_1 or 1_2 without DL assignment including a reserved field indicating the serving cell change command.

In some embodiment, the MAC CE activates one unified TCI state, wherein the one unified TCI state is associated with SSBs associated with a physical cell ID identifying one of candidate target cells, and the serving cell change command indicates to apply the target cell that is the one of the candidate target cells.

In some embodiment, the DCI indicates a physical cell ID indicating one of candidate target cells, as the serving cell change command, and the serving cell change command indicates to apply the target cell that is the one of the candidate target cells. For example, the DCI is a dedicated DCI format or a DCI format 1_1 or 1_2 scrambled by a dedicated RNTI.

In some embodiment, the processor is configured to apply the target cell starting from the first slot that is at least x symbols after the last symbol of PUCCH or PUSCH carrying the HARQ-ACK information for the DCI, wherein x is reported by the UE capability reporting per SCS.

In some embodiment, the processor is further configured to transmit all PDCCH and PDSCH by the unified TCI state, starting from the first slot that is at least x symbols after the last symbol of PUCCH or PUSCH carrying the HARQ-ACK information for the DCI, wherein x is reported by the UE capability reporting per SCS.

In some embodiment, the processor is further configured to transmit, via the transceiver, a CSI report configuration; and receive, via the transceiver, a beam report including one or more beam index or indices with the measured L1-RSRP, where each of the one or more beam index or indices identifies a beam from a different cell whose average L1-RSRP of the top K beams is larger than a configured threshold, wherein the beam report also includes the average L1-RSRP of the top K beams for each cell for which a beam index of a beam is included in the beam report, wherein, K is a preconfigured value.

In some embodiment, the DCI or the MAC CE further indicates a TAG ID. Alternatively, the unified TCI state or the physical cell ID identifying the target cell is associated with a TAG ID.

In yet another embodiment, a method performed at a base unit comprises transmitting a DCI or a MAC CE indicating a serving cell change command for a target cell; and applying the target cell as the new serving cell after receiving HARQ-ACK information for the DCI or the MAC CE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of the first sub-embodiment of the second embodiment;

FIG. 2 is a schematic flow chart diagram illustrating an embodiment of a method;

FIG. 3 is a schematic flow chart diagram illustrating an embodiment of another method; and

FIG. 4 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

At first, a brief introduction of the TCI state is provided as follows:

The UE can be configured with a list of up to M TCI-State configurations to decode PDSCH according to a detected PDCCH with DCI intended for the UE and the given serving cell, where M depends on the UE capability. The TCI-state is configured by the following RRC signaling:

The IE TCI-State associates one or two DL reference signals with a corresponding quasi-colocation (QCL) type.

TCI-State information element

| | |
|---|---|
| TCI-State ::= | SEQUENCE { |
| tci-StateId | TCI-StateId, |
| qcl-Type1 | QCL-Info, |
| qcl-Type2 | QCL-Info |

}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

}

Each TCI-State contains parameters for configuring a quasi co-location (QCL) relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread};
‘QCL-TypeB’: {Doppler shift, Doppler spread};
‘QCL-TypeC’: {Doppler shift, average delay}; and
‘QCL-TypeD’: {Spatial Rx parameter}.

The UE receives an activation command used to map up to 8 TCI states to the codepoints of the DCI field ‘Transmission Configuration Indication’ in one DL BWP of a serving cell.

In NR Release 17, the command for serving cell change, e.g., the handover command, is indicated by RRC signaling which leads to larger handover latency. The handover means the UE shall change its serving cell from a source cell to a target cell. When the handover is successful, the target cell is applied as the new serving cell for subsequent transmission and reception.

To reduce handover latency, this disclosure proposes to perform serving cell change in L1 and L2, e.g., based on DCI and/or MAC CE.

A first embodiment relates to indication of the serving cell change.

When a UE is configured with unified TCI framework, one or more (e.g., up to 128) TCI states can be configured to the UE by RRC signaling in a serving cell. Each configured TCI state may be associated with a PCI (physical cell identity), e.g., by being associated with SSBs associated with the PCI. The PCI identifies a cell. Each cell has a distinct PCI from any other cells. The PCI associated with each configured TCI state may be the same or different from the PCI of the serving cell.

In the following description, “a TCI state being associated with SSBs associated with a PCI” is abbreviated as “a TCI state being associated with a PCI”.

Each configured TCI state can be associated with the PCI identifying the serving cell or any of other PCIs each identifying another cell different from the serving cell. Each of the other cells identified by the other PCIs can be seen as a candidate target cell, i.e., a candidate of the target cell for the serving cell change for L1 and L2 based mobility. Accordingly, a PCI identifying a candidate target cell can be referred to as a candidate target PCI, while the PCI identifying the serving cell is referred to as the serving PCI.

A first sub-embodiment of the first embodiment relates to indication of both the target cell and a serving cell change command in DCI.

When two or more (e.g., 2 to 8) configured TCI states are activated by a MAC CE (e.g., unified TCI state activation MAC CE) for the UE for a BWP of a serving cell, one of the activated TCI states is indicated by a DCI (e.g., DCI with format 1_1 or 1_2) as the unified TCI state for the UE in the BWP. The PCI associated with the indicated unified TCI state can be the serving PCI or a target PCI that is one of the candidate target PCIs.

If the PCI associated with the indicated unified TCI state is the target PCI (identifying the target cell), a serving cell change command triggers the serving cell change to the target cell identified by the target PCI. In other words, the target cell will be applied as the new serving cell.

The serving cell change command can be indicated in the DCI by two alternative options.
Option 1: A new DCI field can be configured in DCI format 1_1 or 1_2 to include the serving cell change command. Option 1 is applicable when the unified TCI state is indicated by DCI format 1_1 or 1_2 with or without DL assignment. DCI format 1_1 or 1_2 without DL assignment means that the DCI is dedicated for unified TCI state indication without scheduling a PDSCH transmission. The details on DCI format 1_1 and DCI format 1_2 are specified in 3GPP Technical Specification TS38.212 V17.3.0.
Option 2: A reserved DCI field in DCI format 1_1 or 1_2 can be used to include the serving cell change command. Option 2 is only applicable when the unified TCI state is indicated by DCI format 1_1 or 1_2 without DL assignment.

Only when the TCI field contained in the DCI format 1_1 or 1_2 indicates a unified TCI state associated with a target PCI (e.g., associated with SSB(s) associated with the target PCI different from the PCI of the serving cell), the UE checks the serving cell change command, i.e., checks the new DCI field or the reserved DCI field including the serving cell change command. The serving cell change command can be one bit contained in the new DCI field (in Option 1) or the reserved DCI field (in Option 2). It means that the UE checks the new DCI field or the reserved DCI field by decoding the new DCI field (in Option 1) or the reserved DCI field (in Option 2). For example, the value ‘1’ of the DCI field (in Option 1) or the reserved DCI field (in Option 2) indicates the serving cell change command, i.e., indicating that the serving cell shall change (or switch) to the target cell identified by the target PCI associated with the indicated unified TCI state. On the other hand, the value ‘0’ indicates that the serving cell does not change (or switch) to the target cell identified by the target PCI associated with the indicated unified TCI state. The value ‘0’ of the new DCI field (in Option 1) or the reserved DCI field (in Option 2) can be referred to as serving cell unchange command.

Otherwise (i.e., if the TCI field contained in the DCI format 1_1 or 1_2 indicates a TCI state associated with the serving PCI (e.g., associated with the SSB(s) associated with the serving PCI) identifying the serving cell, the UE ignores (e.g., by not decoding) the new DCI field (in Option 1) or the reserved DCI field (in Option 2).

A second sub-embodiment of the first embodiment relates to indication of both the target cell and the serving cell change command in MAC CE.

For the UE that only supports one activated TCI state by MAC CE for a BWP of a cell, the unified TCI state is activated (i.e., indicated) by MAC CE. In this condition, the serving cell change command is indicated by a MAC CE (e.g., unified TCI state activation/deactivation MAC CE) activating the one unified TCI state. For example, a MAC CE field (e.g., serving cell change/unchange command field) can be contained in the MAC CE to indicate whether the UE shall change (or switch) to the target cell identified by the target PCI associated with the activated (and indicated) one unified TCI state by the MAC CE. The serving cell change/unchange command field is only valid when the one activated unified TCI state is associated with the target PCI different from the PCI of the serving cell. Similar to the first sub-embodiment, a value ‘1’ of the serving cell change/unchange command field may indicate the serving cell change command while a value ‘0’ of the serving cell change/unchange command field may indicate the serving cell unchange command. Otherwise (i.e., when the one activated unified TCI state is associated with the serving PCI identifying the serving cell), the UE shall ignore (e.g., by not decoding) the serving cell change/unchange command field.

A third sub-embodiment of the first embodiment relates to indication of the target cell in DCI for FR1 operation without configured unified TCI framework.

For FR1 operation without unified configured TCI framework, one or multiple candidate target cells can be configured for the UE (e.g., by RRC signaling) for L1 and L2 based mobility. For example, each candidate target cell is indicated (e.g., configured by RRC signaling) to the UE by a candidate target cell index (e.g., candidate target PCI) identifying the candidate target cell. Each candidate cell is configured with a PCI different from the PCI of the serving cell.

The target cell index, which is one of the candidate target cell indices configured to the UE, indicating the target cell can be directly indicated by a DCI, which can be a dedicated DCI format or a DCI format 1_1 or 1_2 scrambled by a dedicated RNTI. A dedicated field or a reserved field in the DCI can directly indicate the target cell index, from the candidate target cell indices, to identify the target cell.

In the third sub-embodiment of the first embodiment, the direct indication of the target cell index by the DCI is equivalent of the serving cell change command. It means that, upon the UE receiving the DCI directly indicating the target cell index, the UE assumes that it receives the serving cell change command and shall change (or switch) to the target cell identified by the target cell index.

A second embodiment relates to applying the serving cell change, that is, when the target cell is applied as the new serving cell.

The first embodiment describes two alternative indications of serving cell change, i.e., by a DCI (e.g., in the first sub-embodiment and the third sub-embodiment of the first embodiment) or by a MAC CE (e.g., in the second sub-embodiment of the first embodiment).

The first sub-embodiment of the second embodiment relates to applying the serving cell change indicated by DCI.

When the serving cell change is indicated in DCI, the serving cell change will be effective (i.e., the target cell will be applied) after the UE's acknowledgement of the DCI.

When the serving cell change command is indicated by DCI format 1_1 or 1_2 with PDSCH scheduling (referred to as first DCI), the HARQ-ACK corresponding to the scheduled PDSCH is taken as the HARQ-ACK information for the first DCI.

When the serving cell change command is indicated by DCI format 1_1 or 1_2 without DL assignment or another dedicated DCI (collectively referred to as second DCI), the UE should report the HARQ-ACK information for second DCI in a codebook indicated by the second DCI.

It means that additional time is required for the UE to perform the serving cell change (e.g., to the target cell). In particular, the UE transmits a PUCCH or PUSCH carrying HARQ-ACK information (e.g., ACK) for the DCI indicating the serving cell change command and the target cell (which is different from the serving cell). The indicated target cell shall be applied as the new serving cell starting from the first slot that is at least x symbols after the last symbol of the PUCCH or PUSCH, where x is equal to ServingCellChangeCommandAppTime that is reported by the UE capability reporting per SCS.

An example of the first sub-embodiment of the second embodiment is illustrated in FIG. 1. The UE receives a DCI indicating the serving cell change command and the target cell that is identified by the target PCI associated with the unified TCI state indicated in the DCI in slot n. The UE reports, in a PUSCH or PUCCH, HARQ-ACK information (e.g., ACK) for the DCI in slot n+2. The target cell is applied beginning from slot n+5, that is the first slot that is ServingCellChangeCommandAppTime symbols after the last symbol of the PUSCH or PUCCH or carrying the HARQ-ACK information. It means that, from slot n+5, the target cell is taken as the serving cell (i.e., the new serving cell). All the PDCCH and PDSCH shall be transmitted by the gNB and received by the UE by the indicated unified TCI state beginning from slot n+5 (i.e., beginning from the first slot that is ServingCellChangeCommandAppTime symbols after the last symbol of the PUSCH or PUCCH or carrying the HARQ-ACK information). In addition, all the PUCCH and PUSCH shall be transmitted by the UE and received by the gNB by the indicated unified TCI state beginning from slot n+5.

The second sub-embodiment of the second embodiment relates to applying the serving cell change indicated by MAC CE.

Similar to the first sub-embodiment, when the serving cell change is indicated in a MAC CE, the serving cell change will be applied after the UE's acknowledgement to the MAC CE.

The MAC CE is carried by a PDSCH from the gNB to the UE. After receiving the PDSCH carrying the MAC CE indicating the serving cell change, the UE transmits a PUCCH or PUSCH carrying HARQ-ACK information corresponding to the PDSCH carrying the MAC CE.

So, the HARQ-ACK information corresponding to the PDSCH can be taken as the HARQ-ACK information for the MAC CE. The target cell indicated in the MAC CE shall be applied as the new serving cell starting from the first slot that is at least 3 ms after the last symbol of the PUCCH the PUSCH carrying HARQ-ACK information. Upon the target cell being applied, all the PDCCH and PDSCH shall be transmitted by the gNB and received by the UE by the one activated unified TCI state by the MAC CE, and all the PUCCH and PUSCH shall be transmitted by the UE and received by the gNB by the one activated unified TCI state by the MAC CE.

A third embodiment relates to cell level beam report in L1 (layer 1).

An SSB resource can be associated with a PCI. A CSI-RS resource associated with a PCI means a CSI-RS resource QCLed with an SSB resource associated with the PCI with respect to QCL-TypeA and QCL-TypeD.

SSB resources or CSI-RS resources associated with PCIs (including the serving PCI identifying the serving cell and candidate target PCI(s) identifying candidate target cell(s)) can be configured as the channel measurement resource (CMR) for a CSI report configuration for cell level beam report. Upon receiving the CSI report configuration, the UE shall report a beam report including, in addition to L (L can be 1 or more) beams (where each beam is identified by a SSBRI or CRI) associated with different L PCIs (it means that each of L beams is associated with a different PCI) and their measured L1-RSRPs, the average L1-RSRP of the top K beams associated with each of the L PCIs, where the average L1-RSRP of the top K beams associated with each of the L PCIs is larger than a threshold. For example, the L PCIs associated with the largest L average L1-RSRPs of the top K beams are determined. The value of L, the value of K and the threshold can be configured by RRC signaling.

For example, a UE is configured with a CSI report configuration with a CMR containing 32 CSI-RS resources where each of the CSI-RS resource represents a beam), where
CSI-RS #0, CSI-RS #1, . . . , CSI-RS #7 are associated with PCI #0;
CSI-RS #8, CSI-RS #9, . . . , CSI-RS #15 are associated with PCI #1;
CSI-RS #16, CSI-RS #17, . . . , CSI-RS #23 are associated with PCI #2; and
CSI-RS #24, CSI-RS #25, . . . , CSI-RS #31 are associated with PCI #3.

Further, the UE is configured to report 2 (i.e., L=2) beams in the beam report with the criterion that the average L1-RSRP of the top 4 (i.e., K=4) beams associated with each of L=2 different PCIs (among PCI #0, PCI #1, PCI #2, and PCI #3) should be larger than Threshold #1 (i.e., the threshold is Threshold #1).

The UE shall measure the L1-RSRPs of all 32 beams (i.e., CSI-RS #0 to CSI-RS #31) in the CMR, and calculate the average L1-RSRP of the top 4 beams associated with each PCI (i.e., each of PCI #0, PCI #1, PCI #2, and PCI #3), where the top 4 beams are 4 beams that have 4 largest measured L1-RSRPs among all the beams associated with each PCI. Among the four average L1-RSRPs each of which is associated with a separate PCI, two PCIs associated with the largest two average L1-RSRPs each of which is larger than Threshold #1 are selected. Incidentally, if only one of the four average L1-RSRPs is larger than Threshold #1, only one PCI associated with the one average L1-RSRP is selected, while if none of the four average L1-RSRPs is larger than Threshold #1, no PCI is selected. It is assumed that two PCIs are selected.

For each of the two selected PCIs, the beam with the largest L1-RSRP associated with the selected PCI is selected. Between the two selected beams, the larger one is denoted as CRI #1, and the smaller one is denoted as CRI #2, where a CRI is a CSI-RS resource indicator. The L1-RSRP of CRI #1 is denoted as RSRP #1, and the L1-RSRP of CRI #2 is denoted as RSRP #2.

The average L1-RSRP of the top 4 beams associated with the PCI associated with the CSI-RS resource indicated by CRI #1 is denoted as average RSRP #1. The average L1-RSRP of the top 4 beams associated with the PCI associated with the CSI-RS resource indicated by CRI #2 is denoted as average RSRP #2.

It is obvious that among RSRP #1, RSRP #2, average RSRP #1, and average RSRP #2, RSRP #1 is the largest. So, differential average RSRP #1, differential RSRP #2, differential average RSRP #2 are calculated with a reference to the largest measured RSRP (i.e., RSRP #1), that is, differential average RSRP #1=RSRP #1−average RSRP #1; differential RSRP #2=RSRP #1−RSRP #2; and differential average RSRP #2=RSRP #1−average RSRP #2.

The beam report includes the format of {CRI #1, CRI #2, RSRP #1, differential average RSRP #1, differential RSRP #2, differential average RSRP #2}.

A fourth embodiment relates to TA (timing advance) for L1 and L2 signaling trigger mobility.

In NR Release 17, each serving cell is configured with a TAG (TA group) for the UE to obtain the TA for UL transmission in the serving cell (e.g., to one TRP of the serving cell). When the UE moves from coverage of the serving cell to another cell (e.g., target cell), the TRP for UL transmission is changed (e.g., to one TRP of the target cell), which may cause a different TA (e.g., new TA). So, a new TA for the target cell may be required. In NR Release 17 handover (i.e., serving cell change), a new TAG configured for the target cell can be indicated by the L3 handover message.

According to the fourth embodiment, the TAG configured for the target cell shall be indicated to the UE if the serving cell change (e.g., to the target cell) is applied. Each TAG can be identified by a TAG ID. It means that it is necessary to indicate the TAG ID associated with (i.e., configured to) the target cell to the UE.

According to a first sub-embodiment of the fourth embodiment, when the serving cell and one or more candidate target cells are configured by RRC signaling for the UE for L1 and L2 triggered mobility, each cell can be associated with a TAG ID. For example, when unified TCI framework is configured for a UE in a cell and one or more TCI states configured in the cell are associated with a PCI (e.g., the serving PCI, or one of the candidate target PCIs) by RRC signaling, each of the PCIs can be associated with a TAG ID.

When the target PCI is indicated (e.g., the unified TCI state associated with the target PCI is indicated, as in the first sub-embodiment of the first embodiment or in the second sub-embodiment of the first embodiment; or a target PCI is directly indicated, as in the third sub-embodiment of the first embodiment), the serving cell is changed to the target cell identified by the target PCI, and the TA obtained according to the TAG identified by the TAG ID associated with the target PCI is determined as the new TA. The new TA is applied when the target cell is applied, e.g., from the first slot that is at least ServingCellChangeCommandAppTime symbols after the last symbol of the PUCCH or PUSCH carrying the HARQ-ACK information for the DCI indicating serving cell change command and the unified TCI state associated with the target PCI.

According to a second sub-embodiment of the fourth embodiment, each unified TCI state is associated with a TAG ID.

For example, each of the unified TCI states configured by RRC signaling can be associated with a TAG ID. For another example, each of the TCI states activated by a MAC CE (e.g., unified TCI state activation/deactivation MAC CE) can be associated with a TAG ID by the MAC CE. Incidentally, all the TCI states associated with a same PCI shall be associated with a same TAG ID.

According to a third sub-embodiment of the fourth embodiment, one or more TAG IDs are directly indicated by the DCI or the MAC CE indicating the serving cell change command.

For example, a “TAG ID” field can be introduced in the DCI or the MAC CE used to indicate the serving cell change command. When the target cell is indicated along with the serving cell change command, the UE shall further decode the “TAG ID” field to obtain the TAG for the target cell (which is the new serving cell).

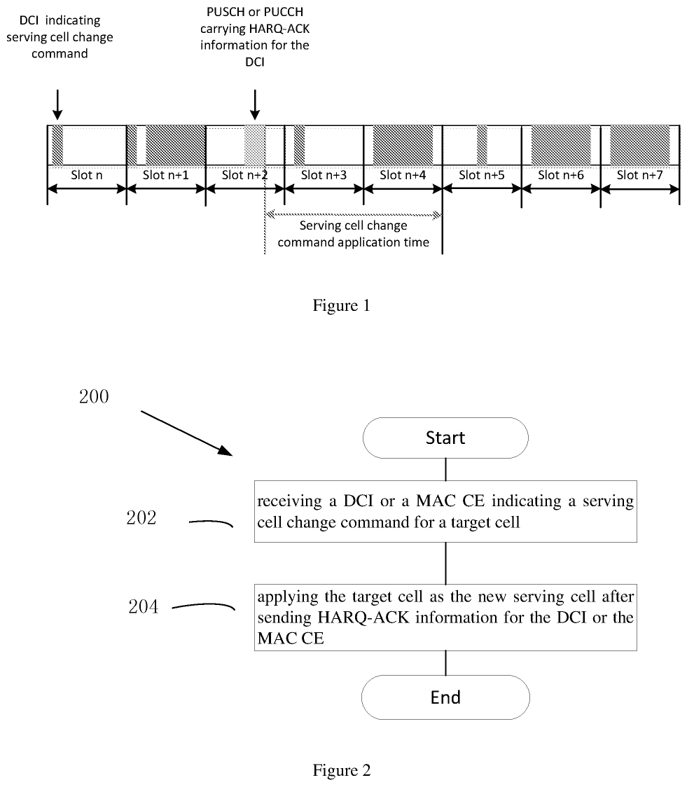

FIG. 2 is a schematic flow chart diagram illustrating an embodiment of a method 200 according to the present application. In some embodiments, the method 200 is performed by an apparatus, such as a remote unit (e.g., UE). In certain embodiments, the method 200 may be performed by a processor executing program code, for example, a microcontroller, a microprocessor, a CPU, a GPU, an auxiliary processing unit, a FPGA, or the like.

The method 200 is a method performed at a UE, comprising: 202 receiving a DCI or a MAC CE indicating a serving cell change command for a target cell; and 204 applying the target cell as the new serving cell after sending HARQ-ACK information for the DCI or the MAC CE.

In some embodiment, the DCI indicates a unified TCI state from activated two or more TCI states, wherein the unified TCI state is associated with SSBs associated with a physical cell ID identifying one of candidate target cells, and the serving cell change command indicates to apply the target cell that is the one of the candidate target cells. For example, the DCI is a DCI with format 1_1 or 1_2 including a new field indicating the serving cell change command, or a DCI with format 1_1 or 1_2 without DL assignment including a reserved field indicating the serving cell change command.

In some embodiment, the MAC CE activates one unified TCI state, wherein the one unified TCI state is associated with SSBs associated with a physical cell ID identifying one of candidate target cells, and the serving cell change command indicates to apply the target cell that is the one of the candidate target cells.

In some embodiment, the DCI indicates a physical cell ID indicating one of candidate target cells, as the serving cell change command, and the serving cell change command indicates to apply the target cell that is the one of the candidate target cells. For example, the DCI is a dedicated DCI format or a DCI format 1_1 or 1_2 scrambled by a dedicated RNTI.

In some embodiment, the method comprises applying the target cell starting from the first slot that is at least x symbols after the last symbol of PUCCH or PUSCH carrying the HARQ-ACK information for the DCI, wherein x is reported by the UE capability reporting per SCS.

In some embodiment, the method further comprises receiving all PDCCH and PDSCH by the unified TCI state, starting from the first slot that is at least x symbols after the last symbol of PUCCH or PUSCH carrying the HARQ-ACK information for the DCI, wherein x is reported by the UE capability reporting per SCS.

In some embodiment, the method further comprises receiving a CSI report configuration; and transmitting a beam report including one or more beam index or indices with the measured L1-RSRP, where each of the one or more beam index or indices identifies a beam from a different cell whose average L1-RSRP of the top K beams is larger than a configured threshold, wherein the beam report also includes the average L1-RSRP of the top K beams for each cell for which a beam index of a beam is included in the beam report, wherein, K is a preconfigured value.

In some embodiment, the DCI or the MAC CE further indicates a TAG ID. Alternatively, the unified TCI state or the physical cell ID identifying the target cell is associated with a TAG ID.

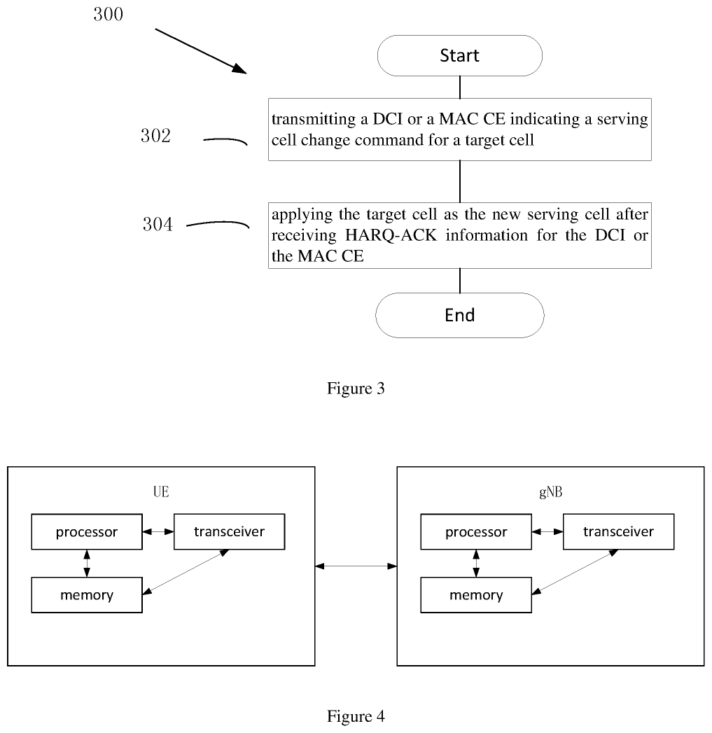

FIG. 3 is a schematic flow chart diagram illustrating an embodiment of a method 300 according to the present application. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may comprise 302 transmitting a DCI or a MAC CE indicating a serving cell change command for a target cell; and 304 applying the target cell as the new serving cell after receiving HARQ-ACK information for the DCI or the MAC CE.

In some embodiment, the DCI indicates a unified TCI state from activated two or more TCI states, wherein the unified TCI state is associated with SSBs associated with a physical cell ID identifying one of candidate target cells, and the serving cell change command indicates to apply the target cell that is the one of the candidate target cells. For example, the DCI is a DCI with format 1_1 or 1_2 including a new field indicating the serving cell change command, or a DCI with format 1_1 or 1_2 without DL assignment including a reserved field indicating the serving cell change command.

In some embodiment, the MAC CE activates one unified TCI state, wherein the one unified TCI state is associated with SSBs associated with a physical cell ID identifying one of candidate target cells, and the serving cell change command indicates to apply the target cell that is the one of the candidate target cells.

In some embodiment, the DCI indicates a physical cell ID indicating one of candidate target cells, as the serving cell change command, and the serving cell change command indicates to apply the target cell that is the one of the candidate target cells. For example, the DCI is a dedicated DCI format or a DCI format 1_1 or 1_2 scrambled by a dedicated RNTI.

In some embodiment, the method comprises applying the target cell starting from the first slot that is at least x symbols after the last symbol of PUCCH or PUSCH carrying the HARQ-ACK information for the DCI, wherein x is reported by the UE capability reporting per SCS.

In some embodiment, the method further comprises transmitting all PDCCH and PDSCH by the unified TCI state, starting from the first slot that is at least x symbols after the last symbol of PUCCH or PUSCH carrying the HARQ-ACK information for the DCI, wherein x is reported by the UE capability reporting per SCS.

In some embodiment, the method further comprises transmitting a CSI report configuration; and receiving a beam report including one or more beam index or indices with the measured L1-RSRP, where each of the one or more beam index or indices identifies a beam from a different cell whose average L1-RSRP of the top K beams is larger than a configured threshold, wherein the beam report also includes the average L1-RSRP of the top K beams for each cell for which a beam index of a beam is included in the beam report, wherein, K is a preconfigured value.

In some embodiment, the DCI or the MAC CE further indicates a TAG ID. Alternatively, the unified TCI state or the physical cell ID identifying the target cell is associated with a TAG ID.

FIG. 4 is a schematic block diagram illustrating apparatuses according to one embodiment.

Referring to FIG. 4, the UE (i.e., the remote unit) includes a processor, a memory, and a transceiver. The processor implements a function, a process, and/or a method which are proposed in FIG. 2.

The UE comprises a transceiver; and a processor coupled to the transceiver, wherein the processor is configured to receive, via the transceiver, a DCI or a MAC CE indicating a serving cell change command for a target cell; and apply the target cell as the new serving cell after sending, via the transceiver, HARQ-ACK information for the DCI or the MAC CE.

In some embodiment, the DCI indicates a unified TCI state from activated two or more TCI states, wherein the unified TCI state is associated with SSBs associated with a physical cell ID identifying one of candidate target cells, and the serving cell change command indicates to apply the target cell that is the one of the candidate target cells. For example, the DCI is a DCI with format 1_1 or 1_2 including a new field indicating the serving cell change command, or a DCI with format 1_1 or 1_2 without DL assignment including a reserved field indicating the serving cell change command.

In some embodiment, the MAC CE activates one unified TCI state, wherein the one unified TCI state is associated with SSBs associated with a physical cell ID identifying one of candidate target cells, and the serving cell change command indicates to apply the target cell that is the one of the candidate target cells.

In some embodiment, the DCI indicates a physical cell ID indicating one of candidate target cells, as the serving cell change command, and the serving cell change command indicates to apply the target cell that is the one of the candidate target cells. For example, the DCI is a dedicated DCI format or a DCI format 1_1 or 1_2 scrambled by a dedicated RNTI.

In some embodiment, the processor is configured to apply the target cell starting from the first slot that is at least x symbols after the last symbol of PUCCH or PUSCH carrying the HARQ-ACK information for the DCI, wherein x is reported by the UE capability reporting per SCS.

In some embodiment, the processor is further configured to receive all PDCCH and PDSCH by the unified TCI state, starting from the first slot that is at least x symbols after the last symbol of PUCCH or PUSCH carrying the HARQ-ACK information for the DCI, wherein x is reported by the UE capability reporting per SCS.

In some embodiment, the processor is further configured to receive, via the transceiver, a CSI report configuration; and transmit, via the transceiver, a beam report including one or more beam index or indices with the measured L1-RSRP, where each of the one or more beam index or indices identifies a beam from a different cell whose average L1-RSRP of the top K beams is larger than a configured threshold, wherein the beam report also includes the average L1-RSRP of the top K beams for each cell for which a beam index of a beam is included in the beam report, wherein, K is a preconfigured value.

In some embodiment, the DCI or the MAC CE further indicates a TAG ID. Alternatively, the unified TCI state or the physical cell ID identifying the target cell is associated with a TAG ID.

The gNB (i.e., the base unit) includes a processor, a memory, and a transceiver. The processor implements a function, a process, and/or a method which are proposed in FIG. 3.

The base unit comprises a transceiver; and a processor coupled to the transceiver, wherein the processor is configured to transmit, via the transceiver, a DCI or a MAC CE indicating a serving cell change command for a target cell; and apply the target cell as the new serving cell after receiving, via the transceiver, HARQ-ACK information for the DCI or the MAC CE.

In some embodiment, the DCI indicates a unified TCI state from activated two or more TCI states, wherein the unified TCI state is associated with SSBs associated with a physical cell ID identifying one of candidate target cells, and the serving cell change command indicates to apply the target cell that is the one of the candidate target cells. For example, the DCI is a DCI with format 1_1 or 1_2 including a new field indicating the serving cell change command, or a DCI with format 1_1 or 1_2 without DL assignment including a reserved field indicating the serving cell change command.

In some embodiment, the MAC CE activates one unified TCI state, wherein the one unified TCI state is associated with SSBs associated with a physical cell ID identifying one of candidate target cells, and the serving cell change command indicates to apply the target cell that is the one of the candidate target cells.

In some embodiment, the DCI indicates a physical cell ID indicating one of candidate target cells, as the serving cell change command, and the serving cell change command indicates to apply the target cell that is the one of the candidate target cells. For example, the DCI is a dedicated DCI format or a DCI format 1_1 or 1_2 scrambled by a dedicated RNTI.

In some embodiment, the processor is configured to apply the target cell starting from the first slot that is at least x symbols after the last symbol of PUCCH or PUSCH carrying the HARQ-ACK information for the DCI, wherein x is reported by the UE capability reporting per SCS.

In some embodiment, the processor is further configured to transmit all PDCCH and PDSCH by the unified TCI state, starting from the first slot that is at least x symbols after the last symbol of PUCCH or PUSCH carrying the HARQ-ACK information for the DCI, wherein x is reported by the UE capability reporting per SCS.

In some embodiment, the processor is further configured to transmit, via the transceiver, a CSI report configuration; and receive, via the transceiver, a beam report including one or more beam index or indices with the measured L1-RSRP, where each of the one or more beam index or indices identifies a beam from a different cell whose average L1-RSRP of the top K beams is larger than a configured threshold, wherein the beam report also includes the average L1-RSRP of the top K beams for each cell for which a beam index of a beam is included in the beam report, wherein, K is a preconfigured value.

In some embodiment, the DCI or the MAC CE further indicates a TAG ID. Alternatively, the unified TCI state or the physical cell ID identifying the target cell is associated with a TAG ID.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

Please make the following amendments to the claims:

1. A user equipment (UE), comprising:
at least one memory; and
at least one processor coupled with the at least one memory and configured to cause the UE to:
receive a downlink control information (DCI) DCI or a medium access control (MAC) control element (CE) MAC-C-E indicating a serving cell change command for a target cell; and
apply the target cell as a new serving cell after sending hybrid automatic repeat request acknowledgment (HARQ-ACK) information for the DCI or the MAC CE.

2. The UE of claim 1, wherein
the DCI indicates a unified transmission configuration indicator (TCI) state from activated two or more TCI states, wherein the unified TCI state is associated with synchronization signal blocks (SSBs) associated with a physical cell identifier (ID) identifying one of candidate target cells, and
the serving cell change command indicates to apply the target cell that is the one of the candidate target cells.

3. The UE of claim 2, wherein the DCI is a DCI with format 1_1 or 1_2 including a new field indicating the serving cell change command, or a DCI with format 1_1 or 1_2 without downlink (DL) DL assignment including a reserved field indicating the serving cell change command.

4. The UE of claim 1, wherein
the MAC CE activates one unified transmission configuration indicator (TCI) state, wherein the one unified TCI state is associated with synchronization signal blocks (SSBs) associated with a physical cell identifier (ID) identifying one of candidate target cells, and
the serving cell change command indicates to apply the target cell that is the one of the candidate target cells.

5. The UE of claim 1, wherein
the DCI indicates a physical cell ID indicating one of candidate target cells, as the serving cell change command, and
the serving cell change command indicates to apply the target cell that is the one of the candidate target cells.

6. The UE of claim 5, wherein the DCI is a dedicated DCI format or a DCI format 1_1 or 1_2 scrambled by a dedicated radio network temporary identifier (RNTI).

7. The UE of claim 1, wherein the at least one processor is configured to cause the UE to apply the target cell starting from a first slot that is at least x symbols after the last symbol of physical uplink control channel (PUCCH) or physical uplink shared channel (PUSCH) carrying the HARQ-ACK information for the DCI, wherein x is reported by a UE capability reporting per subcarrier spacing (SCS).

8. The UE of claim 2, wherein the at least one processor is configured to cause the UE to receive all physical downlink control channel (PDCCH) and physical downlink shared channel (PDSCH) P-DSC-H by the unified TCI state, starting from a first slot that is at least x symbols after the last symbol of physical uplink control channel (PUCCH) or physical uplink shared channel (PUSCH) carrying the HARQ-ACK information for the DCI, wherein x is reported by a UE capability reporting per subcarrier spacing (SCS).

9. The UE of claim 1, wherein the at least one processor is configured to cause the UE to:
receive a channel state information (CSI) report configuration; and
transmit a beam report including one or more beam index or indices with a measured layer 1 (L1)-reference signal received power (RSRP), where each of the one or more beam index or indices identifies a beam from a different cell whose average L1-RSRP of top K beams is larger than a configured threshold, wherein the beam report also includes the average L1-RSRP of the top K beams for each cell for which a beam index of a beam is included in the beam report, wherein, K is a preconfigured value.

10. The UE of claim 1, wherein the DCI or the MAC CE further indicates a TAG identifier (ID).

11. The UE of claim 2, wherein the unified TCI state or the physical cell ID identifying the target cell is associated with a TAG ID.

12. The UE of claim 4, wherein the unified TCI state or the physical cell ID identifying the target cell is associated with a TAG ID.

13. A method performed at a user equipment (UE), the method comprising:
receiving a downlink control information (DCI) or a medium access control (MAC) control element (CE) indicating a serving cell change command for a target cell; and
applying the target cell as a new serving cell after sending hybrid automatic repeat request acknowledgment (HARQ-ACK) information for the DCI or the MAC CE.

14. A base station, comprising:
at least one memory; and
at least one processor coupled with the at least one memory and configured to cause the base station to:
transmit a downlink control information (DCI) DCI or a medium access control (MAC) control element (CE) MAC-CE indicating a serving cell change command for a target cell; and
apply the target cell as a new serving cell after receiving hybrid automatic repeat request acknowledgment (HARQ-ACK) information for the DCI or the MAC CE.

15. A processor for wireless communication, comprising:
at least one controller coupled with at least one memory and configured to cause the processor to:
receive a downlink control information (DCI) or a medium access control (MAC) control element (CE) indicating a serving cell change command for a target cell; and
apply the target cell as the new serving cell after sending hybrid automatic repeat request acknowledgment (HARQ-ACK) information for the DCI or the MAC CE.

16. The processor of claim 15, wherein:
the DCI indicates a unified transmission configuration indicator (TCI) state from activated two or more TCI states, wherein the unified TCI state is associated with synchronization signal blocks (SSBs) associated with a physical cell identifier (ID) identifying one of candidate target cells, and
the serving cell change command indicates to apply the target cell that is the one of the candidate target cells.

17. The processor of claim 16, wherein the DCI is a DCI with format 1_1 or 1_2 including a new field indicating the serving cell change command, or a DCI with format 1_1 or 1_2 without downlink (DL) assignment including a reserved field indicating the serving cell change command.

18. The processor of claim 15, wherein:
the MAC CE activates one unified transmission configuration indicator (TCI) state, wherein the one unified TCI state is associated with synchronization signal blocks (SSBs) associated with a physical cell identifier (ID) identifying one of candidate target cells, and
the serving cell change command indicates to apply the target cell that is the one of the candidate target cells.

19. The processor of claim 15, wherein:
the DCI indicates a physical cell ID indicating one of candidate target cells, as the serving cell change command, and
the serving cell change command indicates to apply the target cell that is the one of the candidate target cells.

20. The processor of claim 19, wherein the DCI is a dedicated DCI format or a DCI format 1_1 or 1_2 scrambled by a dedicated radio network temporary identifier (RNTI).
